(19) United States
(12) Patent Application Publication
(10) Pub. No.: US 2026/0045078 A1
(43) Pub. Date: Feb. 12, 2026

(54) Disassembly Assistance Methods and Systems

(71) Applicant: Siemens Aktiengesellschaft, München (DE)

(72) Inventors: Sebastian Pol, Fürth (DE); Edward Cornelius Krubasik, München (DE); Markus Michael Geipel, München (DE); Fabian Seiler, München (DE); Omar Khaled Abdelmoniem Taha Mohamed Koraa, München (DE); Medhansh Rath, München (DE); Kerim Tosun, München (DE); Pierre Ballif, München (DE); Shubham Joshi, Heidelberg (DE)

(73) Assignee: Siemens Aktiengesellschaft, München (DE)

(21) Appl. No.: 19/294,931

(22) Filed: Aug. 8, 2025

(30) Foreign Application Priority Data
Aug. 8, 2024 (EP) 24193502.2

(51) Int. Cl. G06V 10/82

(52) U.S. Cl. CPC G06V 10/82

(57) ABSTRACT

Various teachings of the present disclosure include disassembly assistance methods. An example includes: visually capturing a product to be disassembled; generating image data for the part; requesting a prompt for a multimodal LLM; transmitting the image data to the LLM module and generating the prompt; generating an output with a disassembly step using the multimodal LLM; transmitting the disassembly data to a visualization module; generating visualization data correlating with the disassembly data using the visualization module; transmitting the visualization data to an image-generating device; generating an image based on the visualization data; displaying the generated image using the image-generating device; detecting a trigger signal corresponding with completion of the disassembly step; and repeating a-k until an abort criterion is reached.

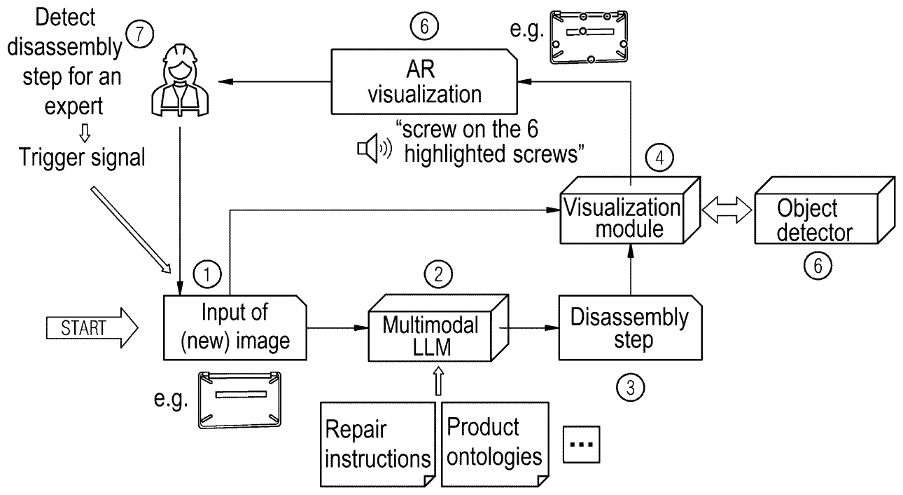

### CROSS-REFERENCE TO RELATED APPLICATIONS

This application claims priority to EP Application No. 24193502.2 filed Aug. 8, 2024, the contents of which are hereby incorporated by reference in their entirety.

### TECHNICAL FIELD

The present disclosure relates to disassembly assistance. Various embodiments of the teachings herein include systems and/or methods for disassembly assistance.

### BACKGROUND

It is known that the disassembly of products is an essential process within the two key modules for implementing a sustainable product lifecycle, namely routine maintenance and end-of-life strategies, in particular remanufacturing. Employees in repair centers are regularly challenged by the fact that they often lack knowledge about the correct disassembly or repair of a product, especially new employees. This is due, among other things, to the large number of products they are confronted with on a daily basis, with new products that they do not yet have any experience with constantly coming along. Searching for repair instructions - if available - and trying to follow the steps usually documented with text and images can often be quite cumbersome.

A known approach to overcoming this problem is to use the so-called “Augmented Reality” (AR) technology to either guide the workers through the repair or to train new arrivals. Typically, however, the implementation of an AR app providing this is hard-coded for the entire disassembly sequence of a particular product. Adjusting the implementation for a new product is therefore very time-consuming and is usually not considered due to a negative cost/benefit balance. To address this situation, automatic generation of disassembly sequences for products can also be considered, but this always depends heavily on prior information such as a CAD model which is required for the AR app and can be used to extract geometric and mobility constraints. However, this prior information is generally not available. In addition, it is usually not possible to link the generated disassembly sequence to proper visualization in an AR app.

### SUMMARY

The teachings of the present disclosure specify technical solutions addressing the disadvantages of the prior art, in particular to improve a degree of automation during repairs. For example, some embodiments of the teachings herein include a disassembly assistance method comprising: a) visually capturing at least one part of a product to be disassembled by means of an image recording apparatus, in particular integrated in AR glasses, b) generating image data for a photo of the part, c) requesting the input of a prompt for a multimodal LLM by means of an LLM module, d) transmitting the image data to the LLM module and generating the prompt at least on the basis of the image data, e) generating an output containing at least one disassembly step by means of the multimodal LLM in order to form disassembly data that at least correlate with the disassembly step on the basis of the prompt, f) transmitting the disassembly data to a visualization module, in particular an AR visualization module, g) generating visualization data that at least correlate with the disassembly data by means of the visualization module, h) transmitting the visualization data to an image-generating device, in particular integrated in the AR glasses, i) generating an image based on the visualization data, j) outputting at least the generated image by means of the image-generating device, k) detecting a trigger signal that correlates at least with the end of the disassembly step, and l) repeating the previous steps until an abort criterion is reached.

In some embodiments, a natural language instruction containing at least the disassembly step is output in parallel with step j).

In some embodiments, the instruction is output as text output, in particular as an overlay on the AR glasses, and/or audio output on a loudspeaker, in particular integrated in the AR glasses.

In some embodiments, the multimodal LLM is trained on the basis of manuals, in particular present as digital data, for example repair manuals, product ontologies and/or further data usable as ontological sources, at least at a first point in time, in particular before initial use of the disassembly assistance method.

In some embodiments, the image data are supplied to a prompt generation process in such a way that the prompt generation process generates the prompt in the manner of the so-called “Retrieval Augmented Generation”, RAG.

In some embodiments, the visualization module is operated in such a way that the disassembly data are supplied to a visualization model, in particular designed as generative AI, in such a way that the visualization model generates the visualization data.

In some embodiments, the visualization module is operated and functionally connected to object recognition, in particular designed on the basis of generative artificial intelligence, in such a way that the object recognition is applied to the photo and generation is carried out in such a way that data that at least correlate with the recognized objects are supplied to the visualization model.

In some embodiments, the trigger signal is generated by actuating an input apparatus, such as a switch, a keyboard, a microphone, camera-supported gesture recognition and/or other human machine interface devices.

In some embodiments, the trigger signal is generated automatically on the basis of an evaluation of camera-supported detection of the disassembly step, which evaluation is in particular supported by artificial intelligence, AI.

As another example, some embodiments include a disassembly assistance arrangement, characterized by means for carrying out one or more of the methods as described herein.

### BRIEF DESCRIPTION OF THE DRAWING

Further advantages and details of the teachings herein are explained in more detail below using an exemplary embodiment shown in the single figure, in which the

Figure (FIG) is a schematic showing an exemplary sequence of the disassembly assistance method incorporating teachings of the present disclosure in an exemplary disassembly assistance arrangement.

### DETAILED DESCRIPTION

Unless stated otherwise in the following description, the terms “carry out”, “implement”, “transform”, “transmit”, “calculate”, “computer-aided”, “compute”, “determine”, “generate”, “configure”, “reconstruct”, “ascertain”, “capture”, and the like relate to operations and/or processes and/or processing steps that change and/or generate data and/or convert data into other data, wherein the data may be represented or be present in particular in the form of physical variables, for example in the form of electrical pulses.

The expression “computer” covers all electronic devices having data processing properties. Computers may thus be for example personal computers, servers, programmable logic controllers (PLC), hand-held computer systems, pocket PC devices, mobile radio devices and other communication devices that are able to process data in a computer-aided manner, processors and other electronic data processing devices. In connection with the disclosure, “computer-aided” may be understood as meaning for example an implementation of a method in which in particular a processor performs at least one element of the method.

In connection with the disclosure, a processor includes a machine or an electronic circuit. In particular, a processor may be a main processor (Central Processing Unit, CPU), a microprocessor, or a microcontroller. A processor may also be for example an IC (integrated circuit), in particular an FPGA (field programmable gate array) or an ASIC (application-specific integrated circuit), or a DSP (digital signal processor) or a graphics processor GPU (graphics processing unit). A processor may also be understood as meaning a virtualized processor, a virtual machine or a soft CPU. It may also be for example a programmable processor that is equipped with configuration steps for performing said method according to the invention or is configured with configuration steps such that the programmable processor implements the inventive features of the method, the component, the modules, or other aspects and/or sub-aspects of the teachings herein.

In connection with the disclosure, a “module” includes at least one processor and/or at least one storage unit for storing program instructions which are connected in a functionally interacting manner physically at one location, for example a part of a printed circuit board. By way of example, the processor may be specifically configured to execute the program instructions such that the processor performs functions for implementing or realizing the methods or a step of the methods described herein.

Some embodiments of the teachings herein include a disassembly assistance method comprising:
a) visually capturing at least one part of a product to be disassembled by means of an image recording apparatus, in particular integrated in AR glasses,
b) generating image data for a photo of the part,
c) requesting the input of a prompt for a multimodal LLM by means of an LLM module,
d) transmitting the image data to the LLM module and generating the prompt at least on the basis of the image data,
e) generating an output containing at least one disassembly step by means of the multimodal LLM in order to form disassembly data that at least correlate with the disassembly step on the basis of the prompt,
f) transmitting the disassembly data to a visualization module, in particular an AR visualization module,
g) generating visualization data that at least correlate with the disassembly data by means of the visualization module,
h) transmitting the visualization data to an image-generating device, in particular integrated in the AR glasses,
i) generating an image based on the visualization data,
j) outputting at least the generated image by means of the image-generating device,
k) detecting a trigger signal that correlates at least with the end of the disassembly step, and
l) repeating the previous steps until an abort criterion is reached.

This example method, which is operated at least partially in a computer-aided manner, improves known disassembly assistance methods in that it can be used virtually without adaptation and automatically for all disassembly tasks. This is helped by the fact that disassembly steps can be captured and forecasts about the next steps can be generated by prompting at least one LLM and can also be visualized automatically. This eliminates the need for individual, in particular manual, setting up of the disassembly assistance for each, in particular new, product type and/or variant. In addition, the process steps of the disassembly assistance method are thus also accelerated, since the data are essentially collected independently and the individual method steps interact in such a way that the visualization data generation and thus also the visualization can take place more quickly and more precisely.

An example disassembly assistance arrangement incorporating teachings of the present disclosure is characterized by means for carrying out the method and/or one of its developments, whereby it contributes to implementing and mutatis mutandis thus to realizing the advantages mentioned in connection with the disassembly assistance method. Further advantageous configurations and developments of the invention are specified by the subclaims.

One example of the disassembly assistance method incorporating teachings of the disclosure includes generating a natural language instruction containing at least the disassembly step in parallel with step j). This can be carried out as an alternative or in addition to other output methods, in particular visual output. This output method can be particularly advantageous if complex and/or multiple disassembly steps need to be carried out and this, in particular on its own, is visually difficult or impossible to present, or viewing a complex visualization would take the attention from the product to be disassembled, and so the disassembly process would be prolonged and there would be the risk of damage due to carelessness.

In some embodiments, the instruction is text output, in particular as an overlay on the AR glasses, and/or audio output on a loudspeaker, in particular integrated in the AR glasses. An output as text is particularly suitable, in particular in the case of simple and/or few disassembly steps, both for clearly describing the disassembly step and not distracting attention from the product too much. Whereas the audio output may be more advantageous in the case of more complex and multiple disassembly steps, since the visual attention can then be 100% on the product because the instruction uses a different sensory channel.

In some embodiments, the multimodal LLM is trained on the basis of manuals, in particular present as digital data, for example repair manuals, product ontologies and/or further data usable as ontological sources, at least at a first point in time, in particular before initial use of the disassembly assistance method. Thus, for example, so-called off the shelf LLM models, such as ChatGPT, which can be used in principle for the invention, can be subjected to so-called fine tuning and thus enable predictions of the LLM that are matched to the domain intended for use and are thus accurate.

In some embodiments, the image data are supplied to a prompt generation process in such a way that the prompt generation process generates the prompt in the manner of the so-called “Retrieval Augmented Generation”, RAG. With this approach, an LLM can also be brought to better predictions, and so this development improves off the shelf LLM model forecasts and also helps already fine-tuned LLMs to achieve an even higher degree of precision of the forecasts.

In some embodiments, the disassembly data are supplied to a visualization model, in particular designed as generative AI, in such a way that the visualization model generates the visualization data, visualization processes matched to the specific domain can be made possible and, as a result, can be implemented in an accurate and time-saving manner.

In some embodiments, the visualization module is operated and functionally connected to object recognition, in particular designed on the basis of generative artificial intelligence, in such a way that the object recognition is applied to the photo and generation is carried out in such a way that data that at least correlate with the recognized objects are supplied to the visualization model, since the assembly parts of the product can be detected by the object recognition and identified using data technology and can thus also be highlighted for visual highlighting in accordance with the disassembly step.

In some embodiments, the trigger signal is generated by actuating an input apparatus, such as a switch, a keyboard, a microphone, camera-supported gesture recognition and/or other human machine interface devices. This makes it possible to indicate verified completion of the current disassembly step, and so the start of any further disassembly step in accordance with the method according to the invention can thus also be initiated.

In some embodiments, the trigger signal is generated automatically on the basis of an evaluation of camera-supported detection of the disassembly step, which evaluation is in particular supported by artificial intelligence, AI. This makes it possible to automatically capture the completion of a disassembly step, and so the start of the possible further disassembly step can be initiated automatically. On the one hand, this saves time, and, on the other hand, the existing capture devices can be used for this purpose, and the repair personnel are relieved of having to make an input, which may also interfere with, or at least delay, the disassembly process under certain circumstances.

The exemplary embodiment explained below in the figure (FIG) is an example embodiment, on the basis of which advantages and further embodiments or developments of the teachings herein are explained in more detail. In particular, the explanations that follow merely show exemplary implementation possibilities, and how in particular such implementations of the teaching could be manifested, since it is impossible and also not helpful or necessary for understanding to name all these implementation possibilities. A person skilled in the relevant art having knowledge of the independent claims is of course also in particular aware of all options for implementing the teachings that are routine in the prior art, and so there is in particular no need for any independent disclosure in the description. The described components each represent individual features of the teachings which should be considered independently of one another, and which each also develop independently of one another and should therefore also be considered to be a constituent part individually or in a combination other than that shown. Furthermore, the described embodiments may also be supplemented by further features that have already been described.

In the single figure FIG, a sequence of a first exemplary embodiment of the method incorporating teachings of the present disclosure, but also of an exemplary embodiment of the arrangement that performs the method, can be seen schematically. In the illustrated exemplary embodiment, it can be seen that, starting from a start time START, an iterative disassembly cycle is initiated.

The disassembly cycle begins in a first step 1 with the fact that a repair worker visually detects a ready-assembled product to be disassembled, which is referred to in the illustration as “input of an image”, and the visual detection is reproduced on an image output device, but the captured image is at least forwarded to a multimodal LLM module. According to the exemplary embodiment, visual detection is performed by way of AR glasses, with which the repair worker looks at the product and initiates the process by taking a photo which is visualized on a display and/or via the AR glasses.

In a second step 2, a multimodal LLM module, which is configured such that it includes vision capabilities, is triggered at least with the captured image as an input signal for an input request (prompt) of the multimodal LLM.

According to the exemplary embodiment, the LLM is matched to a large amount of repair manuals and product ontologies and, based on this, derives a meaningful first disassembly step in text form, which is output by the LLM module in a third step 3 for the next module according to the exemplary embodiment.

In some embodiments, in this second step 2 (not illustrated), a further improvement in the forecast may be achieved via a fine-tuned model and/or with the so-called “Retrieval Augmented Generation” (RAG) technology using relevant information (e.g. a manual) retrieved from a database in order to provide context for the input request.

In some embodiments, the input request in the second step 2 can be enriched by non-textual information such as a CAD model, wherein for this purpose according to one development one or more interfaces/communication connections are used to check whether such a CAD model is available in order to obtain additional information, such as geometric and mobility constraints, if this is the case.

In a fourth step 4, the textual disassembly step derived by the LLM and output as data at the output of the LLM module in the third step 3 triggers, as an input signal or input data of a visualization module, a visualization model which combines the recorded image with the generated disassembly step as input data in order to create the augmented reality visualization.

The combination is facilitated in the example by the fact that the LLM follows a certain ontology when it comes to describing the task. This is further improved according to the exemplary embodiment shown by virtue of the fact that objects to which the task relates, for example screws, as shown, are alternatively or additionally recognized in the image in a fifth step 5 using a trained object detector, for example YOLOv8, and are also visually output there in a sixth step 6 in an AR visualization (AR application, AR APP) generated for the repair worker, for example by drawing a box around those screws which are intended to be screwed on, as shown in the figure.

In some embodiments, as also indicated in the exemplary embodiment, this highlighting may be accompanied by, for example auditory, output of a work instruction. A textual overlay of the work instruction is also possible as an alternative or in addition. With this output or the outputs, the repair worker is now able to physically perform the disassembly step shown in the AR application, i.e. make it real. This process can be captured automatically, for example again by way of the AR glasses, and at the end of the disassembly step currently being performed results in the recording, which is triggered either as part of the automatic capture or by capturing manual initiation, of a new image in the first step 1, thus triggering a further process cycle, at the end of which there is a new disassembly visualization, since the multimodal LLM can draw conclusions about a next disassembly step based on the new state (new image) of the product.

This method can automatically assist with the disassembly of new products without the implementation of the disassembly assistance arrangement and/or of the disassembly assistance method having to be adapted. This is achieved according to the exemplary embodiment, inter alia, by virtue of the AR application, which is used by a repair worker to expand the disassembly assistance arrangement according to the invention as a backend of the AR application in order to produce, among other things, an interface to the multimodal LLM, wherein the AR application iteratively generates and visualizes disassembly sequences.

This makes it possible for the AR application according to the exemplary embodiment to generate meaningful disassembly sequences even for unprecedented products and to also provide feature-rich instructions, for example targeted highlighting of components in the user's view, rather than just displaying text instructions, even for products that have never been seen before, as already emphasized.

Irrespective of the grammatical gender of a specific term, persons with male, female or other gender identity are also included.

1. A disassembly assistance method comprising:
a) visually capturing at least one part of a product to be disassembled by means of an image recording apparatus;
b) generating image data for a photo of the part;
c) requesting input of a prompt for a multimodal LLM using an LLM module;
d) transmitting the image data to the LLM module and generating the prompt based at least in part on the image data;
e) generating an output containing at least one disassembly step using the multimodal LLM to form disassembly data correlating with the disassembly step on the basis of the prompt;
f) transmitting the disassembly data to a visualization module;
g) generating visualization data correlating with the disassembly data using the visualization module;
h) transmitting the visualization data to an image-generating device;
i) generating an image based on the visualization data;
j) displaying the generated image using the image-generating device;
k) detecting a trigger signal corresponding with completion of the disassembly step; and
l) repeating a-k until an abort criterion is reached.

2. The disassembly assistance method as claimed in claim 1, further comprising generating a natural language instruction containing the disassembly step in parallel with j).

3. The disassembly assistance method as claimed in claim 2, wherein the instruction comprises text output.

4. The disassembly assistance method as claimed in claim 1, wherein the multimodal LLM is trained on the basis of manuals.

5. The disassembly assistance method as claimed in claim 1, wherein the image data are supplied to a prompt generation process in such a way that the prompt generation process generates the prompt in the manner of “Retrieval Augmented Generation”, RAG.

6. The disassembly assistance method as claimed in claim 1, wherein
the visualization module is operated in such a way that the disassembly data are supplied to a visualization model so the visualization model generates the visualization data.

7. The disassembly assistance method as claimed in claim 6, wherein the visualization module is operated and functionally connected to object recognition so the object recognition is applied to the photo and generation is carried out so data that correlate with the recognized objects are supplied to the visualization model.

8. The disassembly assistance method as claimed in claim 1, wherein the trigger signal is generated by actuating an input apparatus.

9. The disassembly assistance method as claimed in claim 1, wherein the trigger signal is generated automatically on the basis of an evaluation of camera-supported detection of the disassembly step, which evaluation is supported by artificial intelligence, AI.
